(19) United States
(12) Patent Application Publication
(10) Pub. No.: US 2015/0178325 A1
(43) Pub. Date: Jun. 25, 2015

(54) SYSTEM FOR PROVIDING ACCESS OVER A NETWORK TO USERS OF TRAINING PREFERENCES OF SELECTED INDIVIDUALS

(71) Applicants: Adam Winchester, Ottawa (CA); Geoffrey Winchester, Ottawa (CA)

(72) Inventors: Adam Winchester, Ottawa (CA); Geoffrey Winchester, Ottawa (CA)

(21) Appl. No.: 14/139,168

(22) Filed: Dec. 23, 2013

(51) Int. Cl. G06F 17/30; G06Q 50/00

(52) U.S. Cl. CPC G06F 17/30289; G06Q 50/01

(57) ABSTRACT

A system and method for collecting and sharing publicly recognized athlete's nutritional, physical, mental and/or other key practices during a specific period of time and providing the scientific and practical rationale for said practices. The system includes software that enables users to access specific publicly recognized athlete's profiles and view the personal histories of their favourite athletes and learn what they eat, what warm up and cool down practices they do, their mental focussing techniques and other key practices. Users can also use the application to track their own game schedules and view publicly recognized athletes' twitter feeds. The application also enables users to build their own profile by combining the habits of athletes that they have selected. The invention allows users to have an all-in-one system with nutritional, physical, mental and other routines, connecting to their favourite athletes and a game scheduler.

### FIELD OF THE INVENTION

The present invention pertains to providing a system accessible to users over a network which allows the users access to the nutritional, physical and mental aspects practices of their favourite athletes with a view to improving their own athletic performance and exercise regimes.

### BACKGROUND OF THE INVENTION

All year round, sports arenas have become the second home of amateur athletes. Significant amounts of time, money, and effort are invested in youth sports by parents and coaches to allow young athletes the opportunity to achieve their maximum performance.

When talking about performance with athletes, parents and/or coaches, many questions involving ways to maximize nutritional and exercise routines, with a view to improving athletic performance, have always been asked. It is well known that there are books, websites, software applications and videos that provide a user with general information on nutrition, physical fitness and/or mental fitness. Many of these information sources, however, speak to only one or two of these areas, or generally without reference to specific game preparation practice. Some of these applications do present specific information, but the information is not provided by credible, publicly recognized sources acceptable by the users, nor are they in relation to maximizing performance and recuperation during a specified duration when the sport is played. There is some information that is presented by professional athletes, but it is not specific to preparation or recuperation for a specific period of game play, nor is it provided within a scientific framework that provides the rationale for why players should follow certain game preparation or recuperation practices.

For example, U.S. Pat. No. 6,585,516 B1 (Alabaster) describes a meal builder with picture menus to help user plan meals to achieve personal dietary goals. However, the described meal builder focuses on diet only, not physical or mental training. Moreover, it does not make nutritional recommendations specifically with regard to the time that an athlete is playing a game.

There are patents for assessing and seeking to improve physical capability. For example, U.S. Pat. No. 6,007,459 (Burgess) describes a method and system for providing physical therapy to a human client. This includes the steps of providing an electronic communication link between the client and a therapist, instructing the client to move in certain ways, assessing the client and communicating remedial movements. Another U.S. Pat. No. 7,169,085 (Killin et al.) describes a method and system for assisting a user in performing a self assessment of both physical or functional capability and capacity in order to determine an “exercise” protocol to improve a specific physical capacity. Both of these patents describe a system which is focused on rehabilitation, and not on athletic performance improvement in a specific sport activity. In addition, the exercise protocol is based on a user's self-evaluation and/or requirements—not in regards to a sporting event during a specified period of time.

U.S. Pat. No. 6,461,162 (Reitman) describes a method wherein a team of consultants assists users in enhancing athletic performance by referencing a comprehensive coordinated interactive database of information on injury prevention, injury rehabilitation, nutrition, strength and conditioning and exercise psychology. The website disclosed in this patent states that in-person consultations are preferred, but remote consultations are offered for convenience only. US Patent Publication 2012/0144301 A1 (Bass) describes a system similar to that of U.S. Pat. No. 6,461,162 (Reitman), but with an online or mobile device application which provides personalized fitness, nutrition, motivation, and training information for families of young athletes. These solutions are fundamentally different from the present invention as they seek to provide guidance on what the user should do, whereas the present invention offers the user specific information to maximize performance and enhance recuperation during a specified period of time (e.g. in the 24 hours leading up to the game time and immediately after the game, during a tournament, during play-offs, etc.).

U.S. Pat. No. 6,931,290 (Forest) recognizes the value of enabling the user to benefit from the knowledge and expertise of an “expert” in the field of sport and describes a system for recommending actions during situations in a sport activity based on a series of previously stored recommendations from an expert (i.e. said expert was not involved in providing assessments or guidance to the specific user, but rather had provided the information previously). The software will recommend golf grip, stance, swing based on what an expert would do in a similar situation. However, the user does not have the benefit of selecting the expert whom they accept. Hence, the credibility and relevance of the information may be less significant.

U.S. Pat. No. 7,539,398 B2 (Alderdice et al.), U.S. Pat. No. 6,200,216 B1 (Peppel), U.S. Pat. No. 5,743,801 (Welander), and U.S. Pat. No. 6,680,715 B2 (Blotky et al.) present solutions for sharing electronic hockey cards. However, these patents focus only on player statistics, player photos and player videos. They do not facilitate the sharing of knowledge from selected individual athletes about their own practices and routines that they use to enhance their own sports performance.

Accordingly, what would be beneficial is a system accessible to users over a network which allows the users access to the nutritional, physical and mental aspects on athletes who have achieved publicly recognized status for excellence in their sport, as well as their game preparation information. This would provide two significant benefits to amateur athletes, their parents and coaches. First, information from publicly recognized athletes represents a credible source of information. Publicly recognized athletes are credible sources of information because they have had enough success with applying their own training regimes to achieve public recognition for excellence in their sport. Second, information from the publicly recognized athletes allows the user to pick an athlete that shares similar physical and psychological characteristics as the user, and this allows the user to identify training routines and regimes that are more uniquely applicable to them.

Therefore, there remains a need for a system accessible to users over a network which allows the users access to the nutritional, physical and mental aspects practices of their favourite athletes with a view to improving their own athletic performance and exercise regimes.

### SUMMARY OF THE INVENTION

A general object and advantage of the present invention is to provide an improved system accessible to users over a network which allows the users access to the nutritional, physical and mental aspects practices of their favourite athletes with a view to improving their own athletic performance and exercise regimes.

A further general object and advantage of the present invention is to provide a system accessible to users over a network which allows the users access to the nutritional, physical and mental aspects on athletes who have achieved publicly recognized status for excellence in their sport, as well as their game preparation information. Such information on the particular nutritional, physical and mental aspects, as well as game preparation information, for specific publicly recognized athletes, is not readily available in any centralized, easy to find, cost-effective source, despite the fact that if athletes are not nutritionally, physically and mentally prepared for game-time, their performance will suffer.

In addition to understanding what game preparation routines would be most valuable for them, users (whether they be amateur athletes, coaches, parents or people seeking training advice) want to have an emotional connection with the athletes that they admire. Excellence in sport is dependent not just on nutritional and physical conditioning, but can also comprise emotional commitment and mental focus on the game. The present invention seeks to provide personal background information on the publicly recognized athlete and also incorporating their social networking feed to make it easier for users to connect with the athlete. This connection between the publicly recognized athlete and users of the system also generates significant benefits to the publicly recognized athlete in strengthening their brand, as well as benefits (and therefore cost savings) in marketing the application.

Scientific research and practical experience have taught that there are a number of principles, pertaining to nutrition, physical training, and mental and psychological focus that can be adopted to maximize performance during a game, or training regime. However, the specific application of these principles varies according to the type of sport played, the position in the sport, the physical and psychological characteristics of the athlete, and the preferences and desires of the athlete. Hence, the object of this invention is to create a method and system for developing and sharing profiles of publicly recognized athletes to demonstrate how they have applied these principles to achieve their success. The present system seeks to allow users (whether they be amateur athletes, coaches, parents or people seeking training advice) to select the profiles of specific athletes from a mobile or web-based application so as to benefit from their experiences in selecting practices that work best for them.

The combination of the scientific information with the practical experiences of publicly recognized athletes is one of the key factors, because there are many ways in which the science can be applied. Different types of athletes will select different nutritional, physical and mental preparation schemes based on their personal preferences, the position they play and their style of play. For example, a goalie has very different needs in regards to stamina, bursts of speed and flexibility than the centre athlete in hockey. Athletes with a smaller frame may focus more on speed and agility to develop a competitive advantage, where as larger athletes may focus more on maximizing their strength to enhance their aggressiveness. Similarly, different nutritional plans are important for people with varying sensitivities and preferences. Athletes need to work through trial and error to find out what works best for them. Amateur athletes need a succinct resource that allows them to benefit from the trial and error of the publicly recognized athletes in selecting the specific combinations of food, exercises, mental routines and other practices that best prepare them for their game. While there are solutions that provide general guidance, there is no solution that provides the choices of publicly recognized athletes, within a scientific framework, to help athletes follow protocols during a specified period of time (e.g. in the 24 hours leading up to the game and the cool down period after) to maximize performance and recuperation.

The present method preferably comprises developing a structured process for collecting information from publicly recognized athletes that is of great value to amateur athletes and various other interested individuals. Specifically, it involves gathering information on: what they eat the night before a game, what they eat before the game and what they eat after the game; what warm-up and cool down exercises they do; what mental and psychological self talk they engage in; and other key practices so as to maximize their performance and recuperation during a specified period of time. The method may also comprise developing a structured process for and collecting information on the personal history of the athlete, such as: their favourite early memories of hockey, how they overcame challenges and key decisions and actions they made so as to arrive at their professional status. This information is then preferably provided to the user by way of a mobile application or web-based application.

In accordance with one aspect of the present invention, there is provided a system for providing access to users over a network to training preferences of selected individuals, the system comprising at least one server; a database accessible by the server and the user interface for storing and containing the training preferences and user data provided by the users of the network; at least one user interface including a visual display, the at least one interface being at a location remote from the user interface; connection means for connecting the at least one server, the at least one user interface and the database through the network, allowing the users to access the training preferences and the user data controlled by the server as selected information preferences; selection means for sending the selected information preferences relating to any of the training preferences and the user data to the at least one server and the at least one user interface; displaying the selected information preferences on the at least one user interface.

In accordance with another aspect of the present invention, there is provided a system for collecting and assembling information on nutritional, mental, physical and/or other key practices in a time period leading up to game time and the post-game cool down from publicly recognized athletes, wherein the information collection is guided by scientific principles and practical knowledge of experienced coaches, trainers, nutritionists, psychologists and/or other experienced persons.

In accordance with another aspect of the present invention, there is provided a non-transitory computer readable memory having recorded thereon statements and instructions for execution by a computer for providing access to users over a network to training preferences of selected individuals, comprising means for connecting at least one server, at least one user interface and a database through the network, allowing the users to access the training preferences and the user data controlled by the server as selected information preferences; means for storing the training preferences and user data provided by the users of the network; and means for selecting and sending the selected information preferences from the network to at least one user interface including a visual display; and displaying the selected information preferences on the at least one user interface.

The present system preferably also enables users to track their own game schedules (and automatically populate it in their calendar).

The present system preferably also enables user to build their own profile by combining the training habits and regimes of athletes or other profiled individuals presented on the network that users have selected.

The present system preferably also allows users to vote for the creation of a profile of an athlete who is not already included in the system.

The present system preferably also incorporates the social media feed (e.g. twitter, tumblr, etc.) of the selected publicly recognized athlete. This allows the user to maintain stronger ties with their favourite athletes and strengthen their commitment to the sport. It also allows the publicly recognized athlete to directly market themselves to users, thereby strengthening their branding and saving marketing costs.

In summary, the present system couples scientific information and information from the practical experiences of coaches, trainers, nutritionists, psychologists and other experts with the preparation routines of publicly recognized athletes to maximize performance and recuperation during a specific period of time. It preferably provides profiles of publicly recognized athlete which contains information on their eating habits (including the recipe), videos of the athlete performing his warm-up and cool down, idiosyncratic detail of his journey to the public recognition athletes, tips to help others sharpen their mental edge, and other key practices as well as the publicly recognized athlete's social networking feed, within a system that allows the user to build their own profile and understand scientific and practical principles of game preparation and schedule their games.

Other features and advantages of the present invention will become apparent from the following detailed description and the accompanying drawings, which illustrate, by way of example, the principles of the invention.

A preferred embodiment of the present invention is described below with reference to the accompanying drawings, in which:

### BRIEF DESCRIPTION OF THE DRAWINGS

FIG. 1 is a flow chart providing an overview of an embodiment of the system of the present invention, and illustrating the input sources of information; and

FIG. 2 is a perspective view of an embodiment of the resilient elastically deformable material having at least one sensor therein for monitoring of vital signs of a wearer for use in the protective composite fabric of the present invention.

### DESCRIPTION OF THE PREFERRED EMBODIMENT

It will of course be understood that the present invention may be embodied as a system, a method, or a computer program product. Accordingly, the present invention may take the form of an entirely hardware embodiment, an entirely software embodiment, or an embodiment combining software and hardware aspects. Furthermore, the present invention may take the form of a computer program product on a non-transitory computer-readable storage medium or memory having computer-readable program instructions (e.g., computer software) embodied in the storage medium for use by or in connection with a computer or any instruction execution system. More particularly, the present invention may take the form of web-implemented computer software. Any suitable computer-readable storage medium may be utilized including but is not limited to hard disks, memory, CD-ROMs, DVD-ROMs, Blu-ray, DVD HD, rewritables, USB flash drives, optical storage devices, or magnetic storage devices. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

It will also be understood that the term “user interface”, as used in the context of the present invention, can include, but is not limited to, computer monitors, monitors, display panels, a mobile telephone, mobile device, cellular device, or television, or the like.

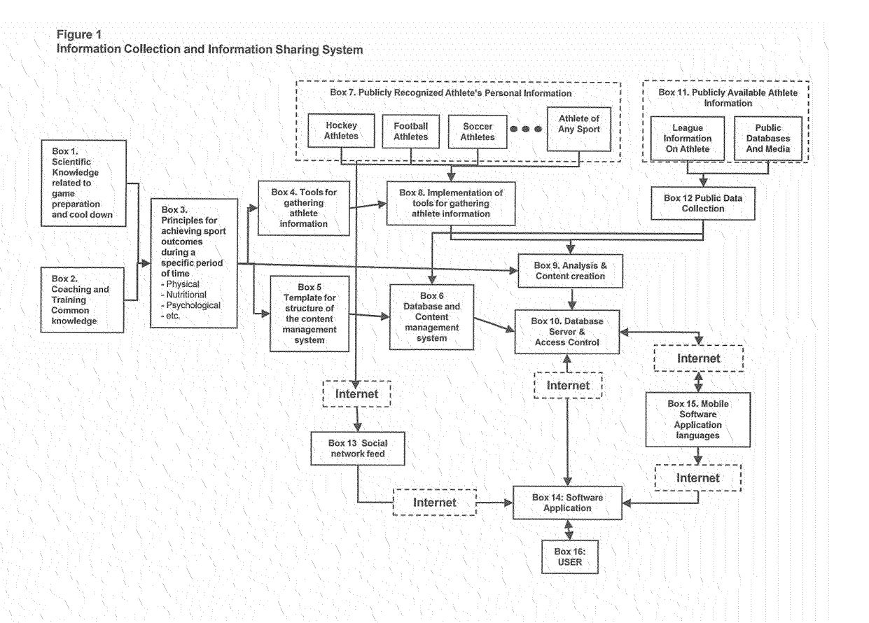

One aspect of the present invention includes the creation of a framework wherein the key principles for maximizing performance and recuperation during a specific period of time (e.g. during the 24 hours leading up to a game and the cool down period after, during a tournament, during play-off season) are identified based on scientific research and the practical experience of coaches, trainers, nutritionists and other experts, and these principles are used to develop a series of tools to collect and share information on how publicly recognized athletes have put those principles into place. This aspect of the present invention is described in greater detail below by reference to the boxes, and flow chart, shown in FIG. 1.

As illustrated in Box 1 and Box 2 of FIG. 1, the scientific research and practical experience of coaches, trainers, nutritionists and other experts and other experts preferably have been reviewed and used to develop critical principles for practices (see FIG. 1, Box 3) to be followed during a specific period of time (e.g. in the 24 hours leading up to a game and the cool down time after, as an example) so as to maximize performance during game time and post game recuperation. For example, recommendations about the quantity and mix of carbohydrates, proteins and fats before and after the game are examples of key nutritional principles that have been developed in FIG. 1, Box 3 for maximizing performance during the game and recuperation after the game that arise from the combination of scientific research and practical training experiences. Similarly, principles around the length and intensity at which metabolic rates should be increased have also been developed based on the combination of scientific research and practical training experiences. Finally, in the examples shown in FIG. 1, Box 3, goal-setting, imagery and arousal regulation have been identified as key drivers of maximum performance. The principles sited herein are examples only; given that scientific research and practical experience are evolving, the principles underlying the application will also evolve through time.

The principles in FIG. 1, Box 3 are used to develop tools and a framework for analysis. As illustrated in FIG. 1, Box 4, one of set of tools that is developed based on the principles in FIG. 1, Box 3 includes a structured contract, interview guide and interview process so as to secure the commitment and provision of appropriate information by the publicly recognized athlete. For example, the nutritional principles in FIG. 1, Box 3 indicate the need for a certain quantity and mix of carbohydrates, proteins and fats before and after the game. However, different athletes will choose different foods to meet these requirements. Constructing the interview guide so as to gather information on specific foods enables the development of the software system that provides the user with specific illustrations of how these principles can be achieved. An alternative set of tools could include surveys, workshop guidelines, an online registration system and/or other methods of obtaining information specific to the publicly recognized athlete, based on a framework of principles as per FIG. 1, Box 3.

As illustrated in FIG. 1, Box 5, the principles in FIG. 1, Box 3 can also be used to develop the template for the database into which the publicly recognized athlete's information will appear. The database is created (see FIG. 1, Box 6), based on the template from FIG. 1, Box 5 and based on consideration of the types of information on publicly available information (see FIG. 1, Box 11) on publicly recognized athletes that helps to establish their credibility or interest to potential users.

Having described how the scientific principles and practical experiences of coaches, trainers, nutritionists, psychologists and other experts can be preferably combined so as to develop a framework and set of tools to gather information from publicly recognized athletes, another aspect of the invention, the process of using the tools to gather, analyze and input information from publicly recognized athletes is now described.

There are two sources of information that are included—personal information from publicly recognized athletes (see FIG. 1, Box 7) and publicly available athlete information (see FIG. 1, Box 11). The process for gathering personal information from publicly recognized athletes (starting with see FIG. 1, Box 7) will be described first.

FIG. 1, Box 7 illustrates that there are various types of sports that this system can be applied to. The physical and psychological demands on the athlete for maximum performance over a specific period of time and recuperation vary by sport. For example, hockey and football require more frequent explosive movements than soccer. Team sports require a different mental focus than individual sports. Consequently, another aspect of the invention is that the principles and structure of the application are varied depending on the sport. FIG. 1, Box 7 illustrates that the system can be applied to various types of sports. However, the principles, the database and the application (i.e. information in all the other boxes) are designed separately for each sport. In order to build profiles of selected publicly recognized athletes, athletes are identified from the sport of interest.

Specific publicly recognized athletes are selected from the universe of publicly recognized athletes (see FIG. 1, Box 7). The selection criteria include a range of factors, such as: the athlete's performance ranking; the athlete's commitment to helping amateur athletes; the athlete's position in a team sport (e.g. goalie versus centre player); the athlete's credibility in the eyes of the public; the challenges that the athlete has overcome; and/or other considerations. The athlete is approached, either by a member of the company, an agent, another player that has been profiled or another authorized person. In the embodiment demonstrated here, if the athlete wishes to be profiled, a contract is signed with them to be profiled in the system and an interview (see FIG. 1, Box 8) is conducted with the publicly recognized athlete. Alternative embodiments of this approach could include a requirement to participate by the athlete's league, team, regulating body or sponsor. Another alternative embodiment of this approach is voluntary self-registration using a self-registration system. In the case of the initial embodiment as described above, the interview consists of two parts.

First, a questionnaire is reviewed wherein the player provides information based on the tools developed in FIG. 1, Box 4. In the embodiment described here, the athlete would provide information on: Nutritional preparation—what they eat the night before the game, what they eat on the day of the game before the game, and after the game; Warm-up and cool down—what exercises they do before and after the game; Mental preparation—what mental exercises they go through during the 24 hours leading up to the game; and their personal history in regards to the sport—favourite memories, how they overcame challenges, etc. The athlete may be audio- or video-taped during this time to allow the information they provide to be relayed via video or audio presentation.

Second, the athlete is video-taped demonstrating various exercises.

As per FIG. 1, Box 9, information, including video-tape footage, is reviewed and analyzed by experts in nutrition, exercise and game psychology. The athlete responses that are most consistent with the principles as identified from the information in FIG. 1, Box 3 are identified and entered into the database (see FIG. 1, Box 10).

In an alternative embodiment to the interview process, the information can also be gathered and entered into an online registration system where the athlete can self-register this information. Specifically, this would involve the athlete filling out the fields in the database as shown in FIG. 1, Box 7, and entering the data into the system (FIG. 1, Box 8), instead of going through an interview process.

In addition to the information on game preparation and cool down practices noted above, additional information can be included in the system. For example, information on player statistics, performance and other information (see FIG. 1, Box 11), will be obtained (FIG. 1, Box 12) and reviewed for consideration of what may be desirable for entry into the database (see FIG. 1, Box 9). The system may also contain a link to the publicly recognized athlete's social networking feed, such as twitter, tumblr, etc. (see FIG. 1, Box 13).

Having described how the scientific principles and practical experiences of coaches, trainers, nutritionists, psychologists and other experts can be preferably combined so as to develop a framework and set of tools to gather information from publicly recognized athletes, and having also described the preferred process of using the tools to gather, analyze and input information from publicly recognized athletes, another aspect of the invention—the development of the software application, and how the user uses the software application—is now described.

In one embodiment, the software application (see FIG. 1, Box 14) comprises a website and/or a mobile software application. The website can be designed in HTML or any other number of programming languages, although any runtime script may be used. In order to be available to users for multiple mobile applications, the mobile software is developed for a wide range of platforms (e.g. iOS, Android, Blackberry, Windows, Symbian, etc., as basic examples). More specifically, the information contained in the database is shared with the user by way of a software application (see FIG. 1, Box 14) that is written in the mobile software language that is relevant to their device, as is well known in the art. The mobile software language also provides the access controls that enable the loading of information into the database.

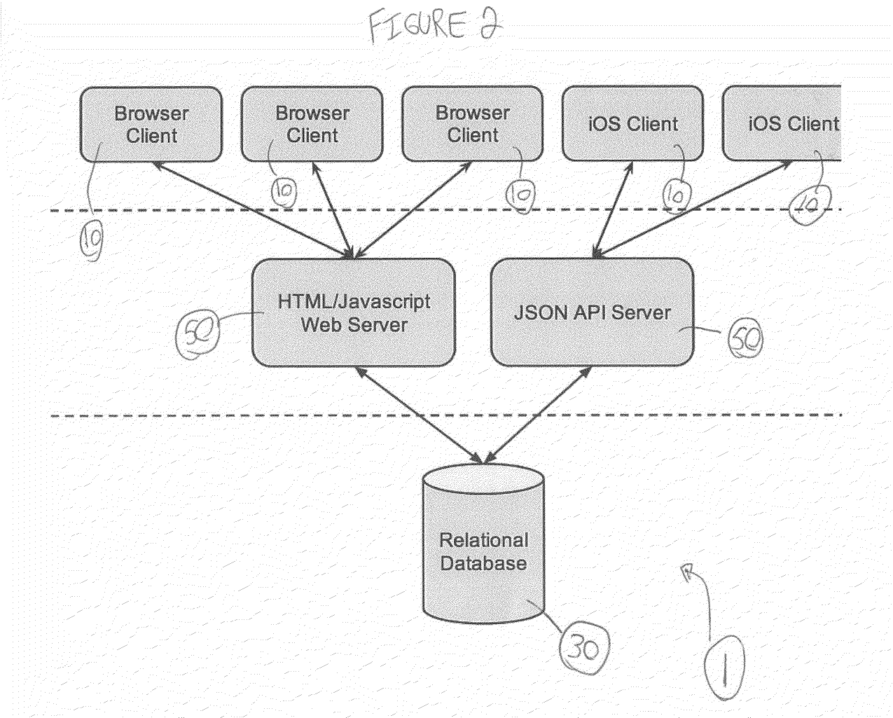

FIG. 2 is a block diagram of an example of the system through which the present invention may be implemented, though it will be understood that numerous variations to this, in terms of setup and arrangement, are possible. Generally speaking, the system of the present invention, and user accessing or have interaction with this system, can be members of a network based community, which are linked to one another by means of a network 1, it being understood that the users 10 accessing the network are connected to one or more servers 50 via the network 1. It will also be understood that the term, “network” as used in the context of the present invention, can refer to a wired network, the Internet, a wireless network, a cellular telephone network, a telecommunications network or a mobile network, for use in conjunction with devices designed to operate on these platforms, such as wireless devices, televisions, monitors, mobile/telephone devices, or any other apparatuses or platform configurations, as would be apparent to one skilled in the art. It is also conceivable that the present invention could be utilized in conjunction with a television environment, and that the network may include a local area network (LAN), a wide area network (WAN), a telephone network, such as the Public Switched Telephone Network (PSTN), an intranet, the Internet, or a combination of networks.

In the context of the present invention, it is also conceivable that the “network” could comprise and link together a plurality of venues in a specific geographic location, such as, for example, Boston, as a local network, and that this local network could be interconnected and linked to one or more other local networks in other geographic locations. Thus, an extensively linked national and globally linked advertising network, in an alternative embodiment of the present invention, is possible, the linking of such networks to one other being accomplished through conventional means, as would be apparent to one skilled in the art.

In one exemplary embodiment, one or more network administrators will also be connected to, and thus have access to (and control over the accessible content of, the network 1.

In the example shown in FIG. 2, five separate users 10, one database 30 and two servers 50 have been illustrated as being connected to network 1 for simplicity, though, in practice, there may be more or fewer users 10, databases 30, advertisers 40 and servers 50 connected to network 1.

It will also be understood that servers 50 may include a processor (not shown) coupled to a computer-readable memory, it being understood that servers 50 may additionally include a secondary storage element, such as their own databases (not shown), as would be apparent to one skilled in the art. Such a database, or database 30 for the system, would be used for storing and containing the training preferences and user data provided by the users of the network, data, personalized profiles of training regimes of users, based on training regimes of selected publicly recognized athletes, as well as the training regimes of selected publicly recognized athletes. This could also comprise interviews and guides, focus group guides, workshop guides, surveys with the selected individuals and publicly recognized athletes, player data, pre-game. warm-ups, post-game cool downs and nutritional, physical and mental information of the selected individuals and publicly recognized athletes, as well, as for example, social media feeds of the publicly recognized athletes available to the users of the network. Further, this could also comprise scheduling criteria for scheduling and storing on the database a game date or training date accessible for selected users on the network (such as a specific team or group of individuals), if desired. This scheduling could be enacted by direct entry by the users, or by information that is uploaded to the network by a league, a coach or an administrative person or body.

Server(s) 50 may operate as, for example, a network server and can include a search engine. In one implementation, search engine may function as a query-based search engine, to locate relevant information in response to search queries. In response to client requests, search engine may return information to users 10 of the network 1, by returning a list of relevant information to the users 10, which relate to information available over the network 1.

The client requests being provided through search engine would comprise information criteria, whereby an advertiser can identify, pinpoint and direct an advertising display towards a specific subset of display screens or display panels at selected venues (or screens at these locations) in the communications network with a view to catering to a specific clientele right at the point-of-sale in the selected venues, thus focusing their marketing efforts thereto. The information criteria entered into the search engine, as noted previously, could comprise, but is not limited to, demographic information from each venue concerning primary and secondary audiences, age group of such audience, lifestyle, ratio of male to female, secondary audiences, location of venue, locations of display panels and screens at each of the venues, and the like.

For example only, an advertiser may wish to tailor an advertising display or marketing materials to venues having a high proportion of a male 18-24 age group, and being predominantly sports oriented. The information may be returned to clients as a listing of venues where this particular demographic is found to be most prevalent. This list of links may be ranked and displayed in an order based on the search engine's determination of relevance to the search query.

It will be understood that entities accessing the network 1 will be utilizing client devices (not shown), which may include a wireless telephone, a personal computer, a personal digital assistant (PDA), a lap top, or another type of computation or communication device, a thread or process running on one of these devices, and/or an object executable by one of these devices. Such client devices will each include a computer-readable medium, such as random access memory, coupled to a processor, for executing program instructions stored in memory, as would be readily apparent to one skilled in the art. Client devices may also include a number of additional external or internal devices, such as, without limitation, a mouse, a CD-ROM, a keyboard, and a display. Of course, through such client devices, entities can communicate over network 1, and with other systems and devices coupled to network 1.

The present invention is a system and method for gathering and sharing publicly recognized athletes' nutritional, physical, mental and other key practices during a specified period of time (e.g. in the 24 hours leading up to game time and the post-game cool down, during a tournament, during play-off season, etc.) within a framework created by using information on scientific research and the practical experience of coaches, trainers, nutritionists, psychologists and other key experts. One aspect of the system comprises an information collection system. Another aspect of the system comprises an information sharing system by way of a software application that enables amateur athletes and their parents and coaches to download profiles of specific publicly recognized athletes. Within the profiles, the user can view the personal histories of their favourite athletes and learn what they eat, what warm up and cool down practices they do, their mental focusing techniques and other key practices. A further aspect of the system includes the enablement of users to input and track their own game schedules (and automatically populate it in their calendar) and view athletes' social networking feeds. Another aspect of the system comprises the enablement of users to build their own profile by combining the habits of athletes that they have selected. Example embodiments of the method and system are described in more detail below by making references to the enclosed figures.

Referring to FIG. 3, and in accordance with an example embodiment of the present invention, there is provided a system for sharing information on athletic game preparation, comprising: an information generating means for generating information on publicly recognized athletes pertaining to the history of their development in the sport and their nutritional, physical, mental practices and/or other key practices in a time period leading up to game time and the post-game cool down, as well as scientific rationale associated with said practices; means for storing the generated information and the scientific rationale; and an information server or means for accessing the stored information and the scientific rationale from a user device.

Preferably, the time period can be configured by a user depending on the preparation need of the user.

Preferably, the time period is at least a few hours ahead of the game of interest. More preferably, the time period is at least 24 hours leading up to a game time of interest.

A further embodiment of the invention is the ability of the application to allow for the entry of information on either users or publicly recognized athletes pertaining to the pursuit of various nutritional, physical, mental and/or other practices and performance outcomes. This affords the opportunity for highly informative statistical analysis of how various practices, or combinations thereof, lead to improved performance and outcomes.

Ultimately, the combination of preparation protocols and the game scheduler, allows the user 10 to organize their preparation based on their calendar. A further embodiment of the invention is the design of the system to enable the coach, league, tournament organizer or other person or body to push the game schedule out to users (e.g. players on a team, parents of players, trainers, etc.).

A further embodiment of the invention is an extension of the application to broader or different time horizons (such as the week before the game, during tournaments, during playoff season, the time leading up to training season, etc.).

Advantageously, the system, method and computer program described herein allow users to develop their own personalized profile of game preparation practices, based on the practices of selected publicly recognized athletes.

Advantageously, the system, method and computer program described herein provide users with a comprehensive, all-in-one system that allows the users to understand the game preparation practices of their favourite athletes and enables them to schedule their preparation around their game time by including a game scheduling function, whether the game scheduling function is via direct entry by the users, or by information that is uploaded to the system by a league, a coach or an administrative person or body.

The present invention has been described herein with regard to preferred embodiments. However, it will be obvious to persons skilled in the art that a number of variations and modifications can be made without departing from the scope of the invention as described herein.

What is claimed is:

1. A system for providing access to users over a network to training preferences of selected individuals, the system comprising:
at least one server;
a database accessible by the server and the user interface for storing and containing the training preferences and user data provided by the users of the network;
at least one user interface including a visual display, the at least one interface being at a location remote from the user interface;
connection means for connecting the at least one server, the at least one user interface and the database through the network, allowing the users to access the training preferences and the user data controlled by the server as selected information preferences;
selection means for sending the selected information preferences relating to any of the training preferences and the user data to the at least one server and the at least one user interface;
displaying the selected information preferences on the at least one user interface.

2. The system of claim 1, wherein the network is the Internet.

3. The system of claim 1, wherein the network is a wired network, a wireless network, a cellular telephone network, a telecommunications network or a mobile network.

4. The system of claim 1, wherein the network is a local area network (LAN), a wide area network (WAN), a telephone network, such as the Public Switched Telephone Network (PSTN), an intranet, the Internet, or a combination of interconnected and linked networks.

5. The system of claim 1, wherein the network can be interconnected and linked to other interconnected and linked networks.

6. The system of claim 1, wherein the training preferences of the selected individuals comprise an interview guide, a focus group guide, a workshop guide, a survey to be administered with the selected individuals, player data, pre-game warm-ups, post-game cool downs and nutritional, physical and mental information of the selected individuals.

7. The system of claim 1, wherein the users subscribe to be members of the network.

8. The system of claim 1, wherein the selected individuals are publicly recognized athletes.

9. The system of claim 8, further comprising means for linking social media feeds of the publicly recognized athletes to be available to the users of the network.

10. The system of claim 8, further comprising means for the users to develop and store on the database or the at least one user interface a personalized profile of a training regime, based on training regimes of selected publicly recognized athletes.

11. The system of claim 1, wherein the system further comprises scheduling means for scheduling and storing on the database a game date or training date accessible to selected ones of the users of the network.

12. The system of claim 1, wherein the scheduling means is enacted by direct entry by the users, or by information that is uploaded to the network by a league, a coach or an administrative person or body.

13. The system of claim 1, wherein the at least one user interface is a computer monitor, a monitor, a display panel, a mobile telephone, mobile device, cellular device, or television.

14. The system of claim 11, wherein the scheduling means can be utilized for scheduling and storing on the database a team, league and/or online registration system that enables registration of players that can be accessed by selected ones of the users of the network.

15. A non-transitory computer readable memory having recorded thereon statements and instructions for execution by a computer for providing access to users over a network to training preferences of selected individuals, comprising:
means for connecting at least one server, at least one user interface and a database through the network, allowing the users to access the training preferences and the user data controlled by the server as selected information preferences;
means for storing the training preferences and user data provided by the users of the network; and
means for selecting and sending the selected information preferences from the network to at least one user interface including a visual display; and
displaying the selected information preferences on the at least one user interface.
